(19) United States
(12) Patent Application Publication
(10) Pub. No.: US 2026/0267766 A1
(43) Pub. Date: Sep. 10, 2026

(54) SYSTEM FOR MONITORING SEMICONDUCTOR PROCESS BASED ON DIGITAL TWIN

(71) Applicant: Inha University Research and Business Foundation, Incheon (KR)

(72) Inventors: Young Shin Han, Incheon (KR); Jongsik Lee, Incheon (KR); Choonsung Nam, Incheon (KR); Bo Seung Kwon, Incheon (KR)

(73) Assignee: Inha University Research and Business Foundation, Incheon (KR)

(21) Appl. No.: 18/871,725

(22) PCT Filed: Aug. 8, 2024
(86) PCT No.: PCT/KR2024/011820

§ 371 Date: Dec. 4, 2024

(30) Foreign Application Priority Data
Sep. 12, 2023 (KR) 10-2023-0121304

(51) Int. Cl. G06F 11/34; G06F 30/27; G06F 119/18; G06F 119/22; H10P 72/00

(52) U.S. Cl. CPC G06F 11/3457; G06F 30/27; H10P 72/0616; G06F 2119/18; G06F 2119/22

(57) ABSTRACT

Disclosed is a system for monitoring a semiconductor process based on a digital twin. A computing device for monitoring a semiconductor process includes at least one processor configured to execute computer-readable instructions included in memory. The at least one processor processes a process of simulating a semiconductor process on a digital twin-based fabrication (FAB) through a data-driven digital twin model consisting of a cyber-physical system (CPS) model that derives same simulation results in a virtual environment based on the past data history of a physical system.

### TECHNICAL FIELD

The following description relates to a technology for monitoring a semiconductor process.

### BACKGROUND ART

It is necessary to improve a semiconductor process due to a verification shortage problem of a semiconductor wafer, a proactive response to the deterioration of equipment, and a production process parameter optimization problem.

Several weeks or more from a wafer process step to the production of a final chip package are consumed to produce a semiconductor. Total inspection through persons and test equipment reach an impossible level due to high precision. If fault equipment and wafer are not discovered at the early stage of a process, massive costs occur when the fault equipment and wafer are discovered in a post-process step.

Furthermore, it is necessary to perform simulations on the same wafer based on the statistics of a previous process, such as the yield, sensor data, and measuring data, because a degree of a fault is different depending on the deterioration degree of equipment for each line. It is necessary to improve the yield and to reduce a fault by applying optimal parameters based on the state of process equipment.

### DISCLOSURE

### Technical Problem

It is possible to predict a semiconductor die or a device under test (DUT) for which a failure or fault of a facility is expected during a process.

It is possible to consistently perform simulations on a total flow of a process on fabrication (FAB) based on a digital twin.

It is possible to prepare a data collection environment for the construction of ultra-large AI based on simulations data for the improvement of a semiconductor process

### Technical Solution

In an embodiment, a computing device may include at least one processor configured to execute computer-readable instructions included in memory. The at least one processor may process a process of simulating a semiconductor process on a digital twin-based fabrication (FAB) through a data-driven digital twin model consisting of a cyber-physical system (CPS) model that derives the same simulation results in a virtual environment based on the past data history of a physical system.

According to an aspect, the at least one processor may predict a semiconductor die or a device under test (DUT) in which a failure or fault of a facility is expected during a process, and may perform virtual metrology in each process step through at least one prediction model, among support vector machine (SVM), K-nearest neighbor (KNN), and random forest (RF) prediction models, based on sensor data collected in a manufacturing facility and test measuring data.

According to another aspect, the at least one processor may share simulation results between digital twin models for individual equipment, and may perform end-to-end (E2E) simulations by associating the simulation results of one digital twin model with another digital twin model as different digital twin models are coupled in parallel.

According to still another aspect, the at least one processor may include an electrical die sorting (EDS) yield prediction model for reducing costs of the semiconductor process, and may detect a defective wafer by using at least one of sensor data, sound measuring data, an image, or video in a post-process step including chipping detection and prediction through a determination of a change in a dicing signal.

According to still another aspect, the at least one processor may include a digital twin system related to the semiconductor process, a server, a learning model, an individual facility, and a hyper converged infrastructure (HCI) framework that constructs a service for an interaction with a worker.

### Advantageous Effects

According to an embodiment of the present disclosure, very strong automation means can be implemented, quality can be significantly improved and productivity can be improved in a production site, and an economic gain can be expected through a reduction of the risk of the semiconductor field, that is, a national undertaking, because a very high-level automation and internal outlier detection system is constructed through a simulation system based on a digital twin with respect to a semiconductor process having complex process parameters and high performance equipment dependency.

According to an embodiment of the present disclosure, it is possible to improve the stability of a process and business efficiency through a complex digital twin system and a hyper converged infrastructure (HCI) framework. It is possible to minimize a production delay problem by monitoring a fine change of equipment in advance. It is possible to construct an economical and efficient production process due to possible measures without the interruption of production in an environment in which a plurality of facilities is used because fault equipment is automatically predicted.

According to an embodiment of the present disclosure, the present disclosure may be expanded to all areas to which production automation is applied in addition to the semiconductor because potential results of a change in the various conditions can be predicted out of the existing outlier detection range through a digital twin-complex simulation system for a semiconductor process.

### DESCRIPTION OF DRAWINGS

FIG. 1 is a block diagram for describing an example of internal components of a computing device in an embodiment of the present disclosure.

FIG. 2 illustrates an example of the initial construction of a data environment in an embodiment of the present disclosure.

FIG. 3 illustrates an example of the utilization of a CNN for the detection of an abnormal pattern of time-series sensing data in an embodiment of the present disclosure.

FIG. 4 illustrates an example of a DT-DT complex simulation structure for a semiconductor process in an embodiment of the present disclosure.

FIG. 5 illustrates an example of a FAB-operation DT system for controlling the entire semiconductor process in an embodiment of the present disclosure.

### BEST MODE

Hereinafter, embodiments of the present disclosure are described in detail with reference to the accompanying drawings.

Embodiments of the present disclosure relate to a technology for monitoring a semiconductor process.

Embodiments including contents that are specifically disclosed in this specification can construct a simulation system based on a digital twin for a semiconductor process and thus can improve a wafer verification problem, a proactive response to the deterioration of equipment, and a production process parameter optimization problem in a semiconductor process.

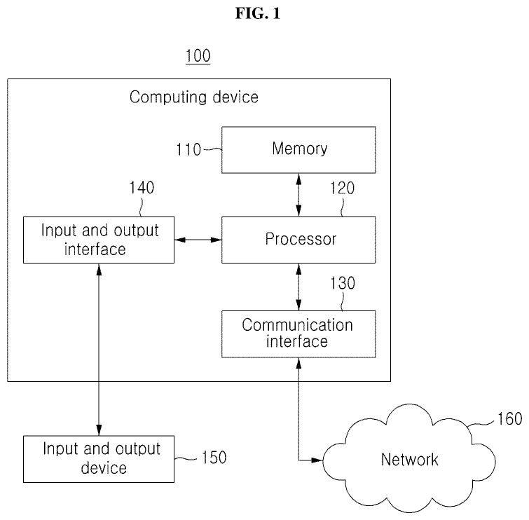

FIG. 1 is a block diagram for describing an example of internal components of a computing device in an embodiment of the present disclosure. For example, a system for monitoring a semiconductor process according to embodiments of the present disclosure may be implemented by a computing device 100 illustrated in FIG. 1.

As illustrated in FIG. 1, the computing device 100 is a component for executing a method of monitoring semiconductor process according to embodiments of the present disclosure, and may include memory 110, a processor 120, a communication interface 130, and an input and output interface 140.

The memory 110 is a computer-readable recording medium, and may include random access memory (RAM), read only memory (ROM), and permanent mass storage devices, such as a disk drive. In this case, ROM and permanent mass storage devices, such as a disk drive, is a separate permanent storage device that is different from the memory 110, and may be included in the computer device 100. Furthermore, an operating system and at least one program code may be stored in the memory 110. Such software components may be loaded from a computer-readable recording medium that is different from the memory 110 onto the memory 110. Such a separate computer-readable recording medium may include computer-readable recording media, such as a floppy drive, a disk, a tape, a DVD/CD-ROM drive, and a memory card. In another embodiment, the software components may be loaded onto the memory 110 through the communication interface 130 not a computer-readable recording medium. For example, the software components may be loaded onto the memory 110 of the computer device 100 based on a computer program that is installed by files that are received over a network 160.

The processor 120 may be configured to process an instruction of a computer program by performing basic arithmetic, logic, and input/output (I/O) operations. The instructions may be provided to the processor 120 by the memory 110 or the communication interface 130. For example, the processor 120 may be configured to execute received instructions based on a program code that has been stored in a recording device, such as the memory 110.

The communication interface 130 may provide a function for enabling the computer device 100 to communicate with another computer system over the network 160. For example, a request, an instruction, data, or a file that is generated by the processor 120 of the computer device 100 based on a program code that has been stored in a recording device, such as the memory 110, may be transferred to other devices over the network 160 under the control of the communication interface 130. Inversely, a signal, an instruction, data, or a file from another device may be received by the computer device 100 through the communication interface 130 of the computer device 100 over the network 160. A signal, an instruction, or data that is received through the communication interface 130 may be transmitted to the processor 120 or the memory 110. A file that is received through the communication interface 130 may be stored in a storage medium (e.g., the aforementioned permanent storage device) which may be further included in the computer device 100.

The communication method is not limited, and may include short-distance wired/wireless communication between devices, in addition to communication methods using communication networks (e.g., a mobile communication network, wired Internet, wireless Internet, and a broadcasting network) which may be included in the network 160. For example, the network 160 may include one or more arbitrary networks of a personal network (PAN), a local network (LAN), a campus network (CAN), a metropolitan network (MAN), a wide network (WAN), a broadband network (BBN), and the Internet. Furthermore, the network 160 may include one or more of network topologies, including a bus network, a star network, a ring network, a mesh network, a star-bus network, and a tree or hierarchical network, but is not limited thereto.

The input and output interface 140 may be means for an interface with an input and output device 150. For example, the input device may include a device, such as a microphone, a keyboard, a camera, or a mouse. The output device may include a device, such as a display or a speaker. Furthermore, for example, the input and output interface 140 may be means for an interface with a device in which functions for an input and an output have been integrated into one, such as a touch screen. The input and output device 150, together with the computer device 100, may be configured as a single device.

Furthermore, in other embodiments, the computer device 100 may include components greater or smaller than the components of FIG. 1. However, it is not necessary to clearly illustrate most of conventional components. For example, the computer device 100 may be implemented to include at least some of the input and output devices 150 or may further include other components, such as a transceiver, a camera, various sensors, and a database.

Hereinafter, detailed embodiments of the system for monitoring a semiconductor process based on a digital twin are described.

First, in the present embodiment, a semiconductor die or a DUT in which a failure or fault of a facility is expected during a process may be predicted. Data that are collected in a manufacturing facility consist of complex data, such as a sensor signal, an image, or video depending on a degree of standardization thereof. The state of the data may be tracked based on the past facility error history data or data during a normal operation interval. It is possible to predict whether a chip that has passed through a reconditioning test (RT) passes through other reliability tests in advance by performing virtual metrology in each process step through a prediction model, such as a support vector machine (SVM), a K-nearest neighbor (KNN), or a random forest (RF) based on sensor data and test measuring data. Accordingly, costs that are consumed for a fault chip can be reduced.

Furthermore, in the present embodiment, simulations may be consistently performed on the entire flow of a process on FAB based on a digital twin. An FAB-monitoring/operation based on a digital twin may be applied to a semiconductor process. It is possible to greatly improve the yield and reduce costs by early discovering a fault by managing the entire semiconductor process through a data-driven digital twin model. The entire process can be consistently verified and simulated through DT-DT parallel simulations in which the digital twin has been coupled in parallel. Analysis, diagnosis, prediction, and optimization may be performed on a semiconductor process based on DT simulations. The entire process can be controlled, a fault die can be tracked, and the yield can also be predicted based on data by applying the digital twin model to the entire semiconductor process based on the sensor data of each of pieces of equipment and the image data of a wafer. A metrology system and algorithm suitable for post-process equipment may be applied because an electrical die sorting (EDS) yield prediction model for reducing the costs of a semiconductor process is included. A facility fault may be predicted in advance through a framework for deriving a machine learning-based facility error occurrence pattern. A defective wafer may be detected by using sensor data, sound measuring, an image, or video in post-process steps, such as chipping detection and prediction, through a determination of a change in the dicing signal.

Furthermore, in the present embodiment, a data collection environment for an ultra-large AI construction may be prepared based on simulation data. A process change can be evaluated in advance with respect to a request from a customer company based on data that are generated in a digital twin (DT) network environment.

A system for monitoring a semiconductor process according to an embodiment of the present disclosure may include a data-driven complex digital twin system for process optimization and monitoring, which may be operable in a smart factory including the semiconductor industry.

The system for monitoring a semiconductor process may consist of (1) a data-driven digital twin (DT) system using the past data history of an individual piece of equipment, (2) a DT-DT complex simulation system in which individual DT simulation models can share simulation results, (3) a model for the estimation of optimal parameters and the prediction of output results for an input based on a database construction using actual process facility sensor data and sensor data, and (4) a framework for controlling DT-DT complex simulations through a single system and a system capable of yield prediction and factory monitoring.
(1) The data-driven digital twin system may be implemented as a cyber-physical system (CPS) model that derives the same simulation results in a virtual environment based on the past sensor data of a physical system (i.e., an FAB process facility) and a system behavior of equipment.
(2) The DT-DT complex simulation system may be implemented as a complex CPS model having a virtual smart factory form, which can transfer the simulation results of a previous DT model to a next DT model when two or more physical twin (PT)-DT pairs are present.
(3) The system for monitoring a semiconductor process may include a database in which the sensor data of a facility to be learnt and the simulation results of the digital twin system can be retained and exchanged in order to predict the product of each digital twin model and a simulation model for predicting the final simulation output results of DT pairs.
(4) The system for monitoring a semiconductor process may consist of the entire complex digital twin system and server, a learning model, and a framework of hyper converged infrastructure (HCI) that constitutes a service for communication with an individual facility and an interaction with a worker.

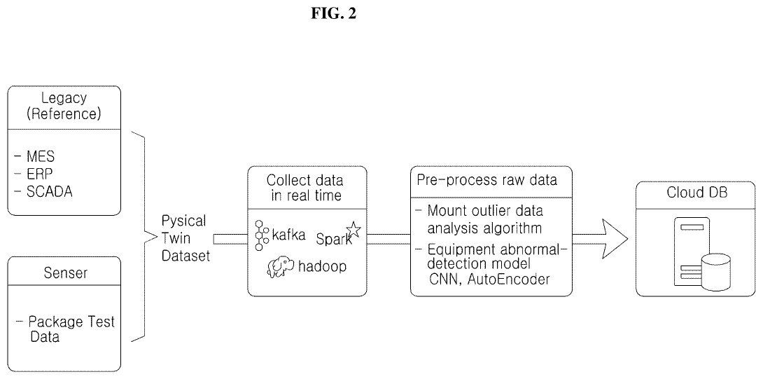

FIG. 2 illustrates an example of the initial construction of a data environment in an embodiment of the present disclosure.

Referring to FIG. 2, the processor 120 may collect data, such as operations and quality that are generated in a process for a target to be analyzed. In this case, the collected data may be used to construct a smart system for a semiconductor process.

To this end, the processor 120 may set a range in which data can be collected, and may apply a deep learning/machine learning function to each process, that is, a target from which data will be collected. A database may be constructed based on the collected data so that data generated in digital twin virtual metrology (VM) can be stored.

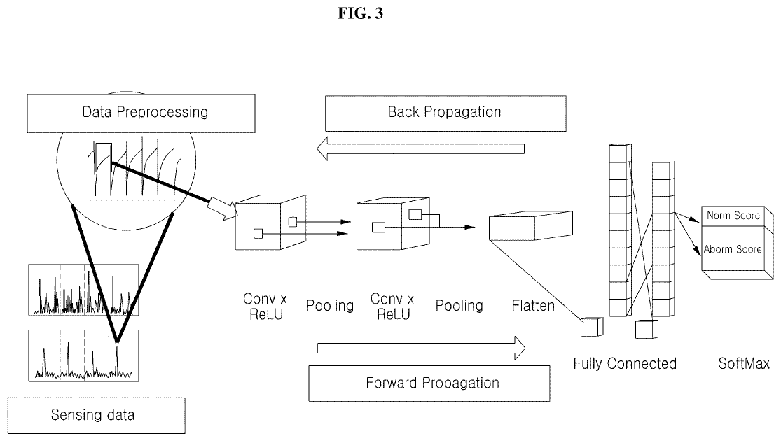

Furthermore, the processor 120 may derive vital few through the analysis of a fault and cause factor correlation by using package tester equipment data. In this case, a convolution neural network (CNN)-based AudoEncoder model may be used as an abnormal detection-early prediction model. FIG. 3 illustrates an example in which a 2D-CNN for the detection of an abnormal pattern of time-series sensing data is used.

Furthermore, the processor 120 may select a base model for the prediction of a fault in a semiconductor test process and perform a pre-test based on the base model.

In the present embodiment, outlier data may be removed by using a machine learning algorithm (e.g., anomaly detection-SVDD) in a data collection process.

In order to construct the DT system for a semiconductor process, domain knowledge may be secured and a corresponding component may be designed so that the system can be decomposed for each step and reassembled into a virtual physical system along with a semiconductor facility and process expert.

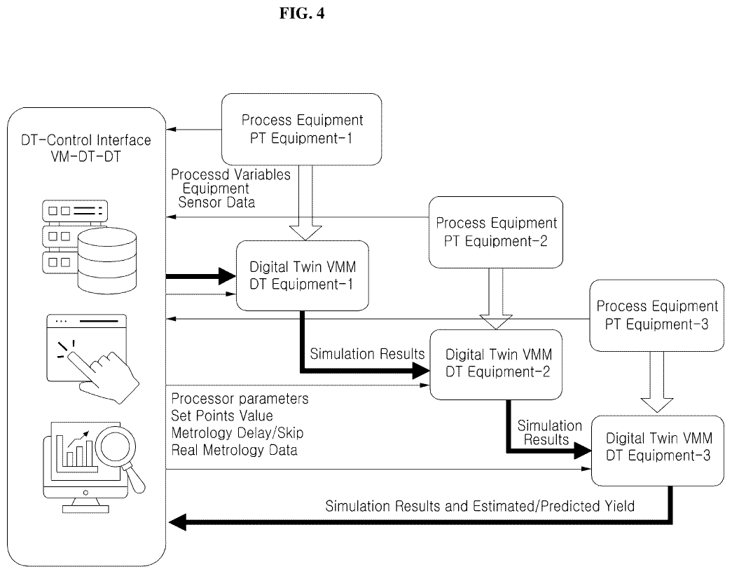

FIG. 4 illustrates an example of a DT-DT complex simulation structure for a semiconductor process in an embodiment of the present disclosure.

Referring to FIG. 4, the system for monitoring a semiconductor process according to an embodiment of the present disclosure may include a DT-control interface for checking an optimization method of individual process equipment based on data that are accumulated in a semiconductor process and exchanging simulation input/output data between digital twin VMs.

The DT model may perform proper prediction and learning on the digital twin VM by applying a model, such as a data-driven bidirectional LSTM (BLSTM), so that the omission of data, non-linear distribution data, and a parameter loss can be handled, and may predict a virtual product by simulating the results of the prediction and learning again.

In other words, the type of simulations, such as discrete and continued events, may be defined. The DT model may be optimized so that the sensor output of an input can be predicted by applying a time-series model, such as the data-driven BLSTM.

In the design of a data exchange interface, it is difficult to track a data connection by using correlation analysis between different virtual system models. However, if the input/output results of each CPS model can be tracked through the digital twin, the final product can be predicted as the results of continuous simulations. To this end, an interface may be provided so that the output results of each CPS model can be organically handed over.

An interface for the DT-DT model may be constructed by using the construction of an environment for the processing of real-time large-quantity data and distributed streaming platforms, such as Apache Kafka, Apache Spark, and Apache Hadoop.

Moreover, in the present embodiment, the DT-DT system may be constructed so that a facility error occurrence pattern can be estimated by using real process facility data. A framework capable of monitoring a plurality of VMs may be provided.

As the DT-DT model, the system may be expanded so that end-to-end (E2E) simulations can be performed on the product that is output by a single DT system after simulations in association with a next DT.

In the construction of the DT-DT system, dynamical evolution learning may be performed online through parameter learning, function learning, and component learning. A model capable of performing analysis, a design, and optimization may be advanced based on cooperation with a real system.

In the DT system monitoring framework, a framework of HCI that constructs a service for communication with the entire complex digital twin system and server, a learning model, and an individual facility, and an interaction with a worker may be constructed.

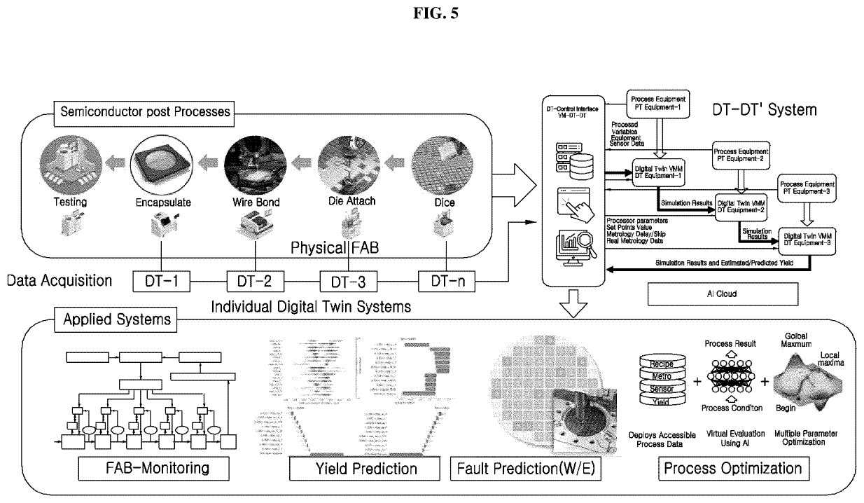

An FAB-operation DT system for controlling the entire semiconductor process may be constructed based on the integrated DT system. FIG. 5 illustrates an example of the FAB-operation DT system for controlling the entire semiconductor process in an embodiment of the present disclosure. When outlier is detected in the results of FAB-operation simulations, a worker may be provided with notification so that the worker can find process equipment that is expected to be problematic through back tracking for individual process equipment and take a preemptive action.

In the present embodiment, the FAB-operation DT system for controlling the entire semiconductor process and finding optimal process parameters may be provided. The FAB-operation DT system may predict remaining useful life through the time, space usage/occupancy, a production volume, a passing rate, a growth rate, work efficiency, and an equipment operating ratio, and may be used for the learning of an ultra-large AI model capable of predicting the yield and estimating optimal parameters when system operation conditions are changed through virtual simulations based on various scenarios. The estimation of optimal process parameters may be said to be an advanced area of the DT system which enables detailed parameters for each piece of suitable process equipment to be inversely found when various characteristics of a chip to be produced are input.

As described above, according to embodiments of the present disclosure, very strong automation means can be implemented and quality can be significantly improved and productivity can be improved in a production site by constructing a very high-level automation and internal outlier detection system through the digital twin-based simulation system for a semiconductor process having complex process parameters and high performance equipment dependency. An economic gain can be expected through a reduction of the risk of the semiconductor field, that is, a national undertaking. Furthermore, according to an embodiment of the present disclosure, the stability and business efficiency of a process can be improved through the complex digital twin system and HCI framework. A production delay problem can be minimized by monitoring a fine change of equipment in advance. An economical and efficient production process can be constructed through measures without the interruption of production in an environment in which a plurality of facilities is used because fault equipment is automatically predicted. Furthermore, according to an embodiment of the present disclosure, the present disclosure may be applied to all areas to which production automation is applied in addition to the semiconductor because the potential results of a change in various conditions can be predicted out of the existing outlier detection range through the DT-DT complex simulation system for a semiconductor process.

The aforementioned device may be implemented with a hardware component, a software component, and/or a combination of a hardware component and a software component. For example, the device and component described in the embodiments may be implemented by using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other device capable of executing or responding to an instruction. The processing device may perform an operating system (OS) and one or more software applications that are executed on the OS. Furthermore, the processing device may access, store, manipulate, process, and generate data in response to the execution of software. For convenience of understanding, one processing device has been illustrated as being used, but a person having ordinary knowledge in the art may understand that the processing device may include a plurality of processing elements and/or a plurality of types of processing elements. For example, the processing device may include a plurality of processors or one processor and one controller. Furthermore, another processing configuration, such as a parallel processor, is also possible.

Software may include a computer program, a code, an instruction or a combination of one or more of them, and may configure a processing device so that the processing device operates as desired or may instruct the processing devices independently or collectively. The software and/or the data may be embodied in any type of machine, component, physical device, or computer storage medium or device in order to be interpreted by the processing device or to provide an instruction or data to the processing device. The software may be distributed to computer systems that are connected over the network 160, and may be stored or executed in a distributed manner. The software and the data may be stored in one or more computer-readable recording media.

The method according to an embodiment may be implemented in the form of a program instruction executable by various computer means, and may be stored in a computer-readable medium. In this case, the medium may continue to store a program executable by a computer or may temporarily store the program for execution or download. Furthermore, the medium may be various recording means or storage means having a form in which one or a plurality of pieces of hardware has been combined. The medium is not limited to a medium that is directly connected to a computer system, but may be ones that are distributed and present in the network 160. Examples of the medium may be magnetic media such as a hard disk, a floppy disk, and a magnetic tape, optical media such as CD-ROM and a DVD, magneto-optical media such as a floptical disk, and ones configured to store a program command, including ROM, RAM, and flash memory. Furthermore, examples of another medium may include an app store in which apps are distributed, a site in which other various pieces of software are supplied or distributed, and recording media and/or storage media that are managed in a server.

### MODE FOR DISCLOSURE

As described above, although the embodiments have been described in connection with the limited embodiments and the drawings, those skilled in the art may modify and change the embodiments in various ways from the description. For example, proper results may be achieved although the aforementioned descriptions are performed in order different from that of the described method and/or the aforementioned elements, such as the system, configuration, device, and circuit, are coupled or combined in a form different from that of the described method or replaced or substituted with other elements or equivalents.

Accordingly, other implementations, other embodiments, and the equivalents of the claims fall within the scope of the claims.

1. (canceled)

2. (canceled)

3. (canceled)

4. (canceled)

5. (canceled)

6. A computing device comprising:
at least one processor configured to execute computer-readable instructions included in memory,
wherein the at least one processor is configured to:
process a process of simulating a semiconductor process on a digital twin-based fabrication (FAB) through a data-driven digital twin model consisting of a cyber-physical system (CPS) model that derives same simulation results in a virtual environment based on a past data history of a physical system;
predict a semiconductor die or a device under test (DUT) in which a failure or fault of a facility is expected during a process, perform virtual metrology in each process step through at least one prediction model, among support vector machine (SVM), K-nearest neighbor (KNN), and random forest (RF) prediction models, based on sensor data collected in a manufacturing facility and test measuring data, and predict whether a chip that has passed through a reconditioning test (RT) passes through other reliability tests in advance, wherein the data collected in the manufacturing facility consist of complex data, such as a sensor signal, an image, or video, and a state of the data is tracked based on the past facility error history data or data during a normal operation interval;
share simulation results between digital twin models for individual equipment, and perform end-to-end (E2E) simulations by associating simulation results of one digital twin model with another digital twin model as different digital twin models are coupled in parallel, wherein the digital twin model is applied to the entire semiconductor process based on the sensor data of each of pieces of equipment and the image data of a wafer;
utilize an electrical die sorting (EDS) yield prediction model for reducing costs of the semiconductor process, and detect a defective wafer by using at least one of sensor data, sound measuring data, an image, or video in a post-process step comprising chipping detection and prediction through a determination of a change in a dicing signal;
manage a database in which the sensor data of a facility to be learnt and the simulation results of the digital twin system are retained and exchanged in order to predict the product of each digital twin model;
interact with a digital twin system related to the semiconductor process, a server, a learning model, and an individual facility through a hyper converged infrastructure (HCI) framework that constructs a service for an interaction with a worker;
set a range in which data is collected, construct a database based on the collected data so that data generated in digital twin virtual metrology (VM) is stored, derive vital few through the analysis of a fault and cause factor correlation by using package tester equipment data, apply a convolution neural network (CNN)-based AutoEncoder model as an abnormal detection-early prediction model, and select a base model for the prediction of a fault in a semiconductor test process and perform a pre-test based on the base model, wherein domain knowledge is secured and a corresponding component is designed so that the system is decomposed for each step and reassembled into a cyber-physical system (CPS) in order to construct the digital twin system for the semiconductor process;
operate a DT-control interface for exchanging simulation input/output data between digital twin VMs, wherein the digital twin model predicts a virtual product by applying a data-driven bidirectional LSTM (BLSTM) model so that the omission of data, non-linear distribution data, and a parameter loss are handled, and predicts the final product as the results of continuous simulations by tracking the input/output results of each CPS model through the digital twin;
monitor a plurality of VMs through a DT-DT system in which the digital twin has been coupled in parallel so that a facility error occurrence pattern is estimated by using real process facility data; and
provide a worker with notification so that the worker finds process equipment that is expected to be problematic through back tracking for individual process equipment when an outlier is detected in the results of FAB-operation simulations.
